(19) United States
(12) Patent Application Publication
(10) Pub. No.: US 2015/0087414 A1
(43) Pub. Date: Mar. 26, 2015

(54) CLOUD GAMING IMPLEMENTED USING A MOBILE DEVICE AND A DISPLAY DEVICE

(71) Applicants: Cellco Partnership d/b/a Verizon Wireless, Arlington, VA (US); Verizon Patent and Licensing, Inc., Arlington, VA (US)

(72) Inventors: Lily F. Chen, Fort Lee, NJ (US); Te-Sheng Lin, Cresskill, NJ (US)

(73) Assignees: CELLCO PARTNERSHIP D/B/A VERIZON WIRELESS, Arlington, VA (US); VERIZON PATENT AND LICENSING, INC., Arlington, VA (US)

(21) Appl. No.: 14/038,224

(22) Filed: Sep. 26, 2013

(51) Int. Cl. A63F 13/12

(52) U.S. Cl. CPC A63F 13/12
USPC 463/31; 463/39; 463/37

(57) ABSTRACT

Techniques are described herein in which a mobile device may enable cloud gaming. In one implementation, the mobile device may receive an information stream, from a remote game server, relating to an online game. The method may further include receiving user input relating to the online game; transmitting the user input to the game server; and screencasting, to a local display device, a video stream that is based on the information stream, the video stream representing a display corresponding to the online game.

### BACKGROUND

Cloud gaming (also called “online gaming”) may refer to the playing of games on various consumer devices without requiring a video gaming console or high-end personal computer. In cloud gaming, the game logic and processing may be predominately handled by remote game servers (e.g., in the cloud) instead of on the local consumer device. The consumer device may run a relatively light weight application that may handle user input and display of the game. The consumer device may communicate control messages to the gaming servers, which may run most or all of the actual game logic.

Cloud gaming may not require the digital download or installation of games, as the game logic may remain at the game servers. A benefit of cloud gaming is that the consumer may not need to purchase a video gaming console or a high-end personal computer that is capable of driving high-end graphics.

### BRIEF DESCRIPTION OF THE DRAWINGS

FIG. 1 is a diagram illustrating an overview of concepts described herein;

FIG. 2 is a diagram illustrating an example environment in which systems and/or methods described herein may be implemented;

FIG. 3 is a diagram illustrating one example of an implementation of a wireless network;

FIG. 4 is a diagram illustrating an example of functional components that may be included within a gaming client;

FIGS. 5A and 5B are diagrams illustrating example device configurations for receiving user input during a game;

FIGS. 6 and 7 are flow charts illustrating example processes relating to the providing of a cloud game using a mobile device and a display device;

FIG. 8 is a diagram conceptually illustrating an example implementation of a multiplayer game implemented using mobile devices and display devices;

FIG. 9 is a diagram illustrating an example of an implementation in which multiple users may use a single display device to play an online game; and

FIG. 10 is a diagram of example components of a device.

### DETAILED DESCRIPTION OF PREFERRED EMBODIMENTS

The following detailed description refers to the accompanying drawings. The same reference numbers in different drawings may identify the same or similar elements.

Techniques are described herein in which a mobile device may act as a local communication node to enable cloud gaming. The mobile device may receive a gaming stream, such as a video stream, from a game server that is providing a game to a user of the mobile device. The mobile device may display the gaming stream on a display device, such as a television. The mobile device may also receive user input relating to the game, such as user input provided by direct interaction with the mobile device (e.g., through a touch screen) or user input provided by a gamepad connected to the mobile device. The mobile device may forward the user input to the game server for processing.

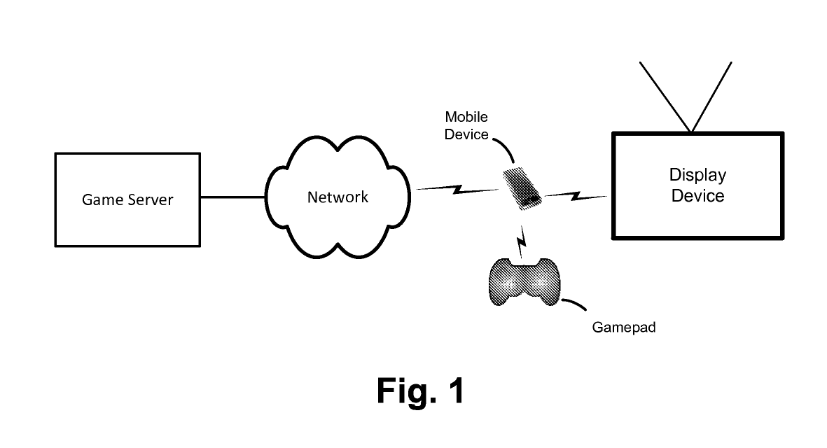

FIG. 1 is a diagram illustrating an overview of concepts described herein. As illustrated, a game server may communicate with a mobile device using a network. The mobile device may include, for example, a mobile phone or smart phone that communicates with the network using a wireless connection (e.g., wireless cellular connection). The mobile device may function as a local communication node for the game server, in which the game server performs most or all of the game-specific logic, for a particular game, and transmits a game stream to the mobile device. The game stream may include, for example, an audio/video signal that represents the user interface of the particular game, or the game stream may include additional information that can be converted, by the mobile device, to an audio/video signal that represents the user interface of the particular game.

The mobile device may display the audio/video signal corresponding to the game stream on the display device. For example, a screencasting technology may be used to facilitate the display of the audio/video signal on the display device. Because the display device may be, for example, a television, with a relatively large display and/or high quality speaker system, the game experience of the particular game may be increased relative to a user playing the game entirely on the mobile device.

The mobile device may also handle user input relating to the game. For example, input elements that are integrated within the mobile device, such as a touch screen display, speaker, gyroscope, or accelerometer, may be used to receive user input relating to the game, which may then be transmitted to the game server. As another example, the mobile device may be coupled with an external gamepad that may provide user input to the mobile device, which may then be transmitted to the game server.

By using a mobile device as a local communication node that is coupled to a remote game server, cloud-based games can be provided on relatively large display devices (e.g., televisions), using network connectivity that is provided by the mobile device without needing to install or update software associated with the display device. Software associated with mobile devices may be relatively easy to update and/or install, thus enabling gaming client software, installed at the mobile device, to be up-to-date. Additionally, due to the relatively large installed base of mobile devices, most users will not be required to purchase additional computing devices in order to participate in the cloud-based games provided by the game server.

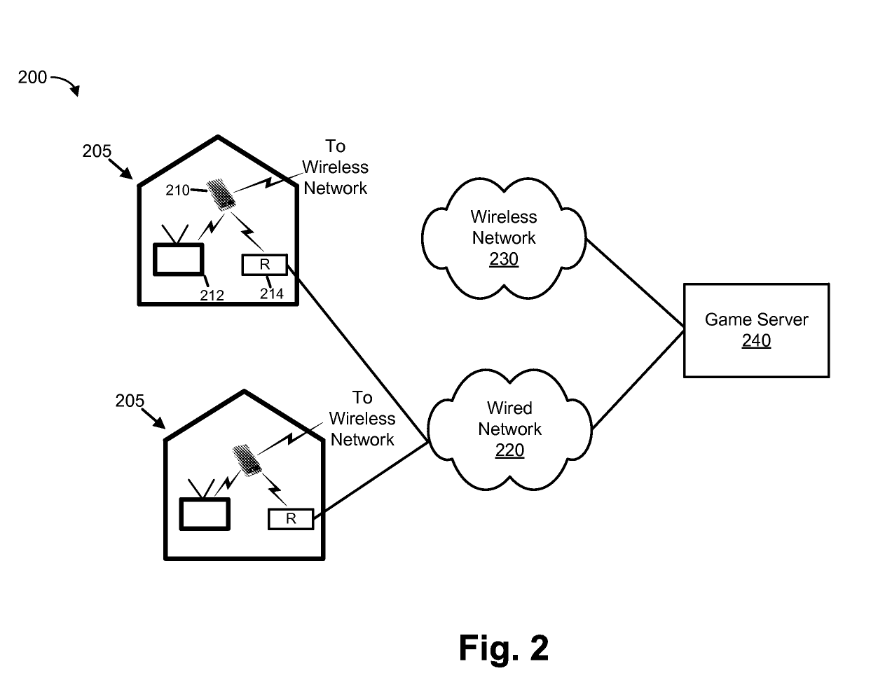

FIG. 2 illustrates an example environment 200 in which systems and/or methods described herein may be implemented. As shown in FIG. 2, environment 200 may include a number of customer premises 205. Network connectivity may be provided to customer premises 205 using a number of possible network technologies, such as via wired network 220 and/or wireless network 230. Game server 240 may connect, through wired network 220 and/or wireless network 230, to computing devices in customer premises 205.

Each of customer premises 205 may include a number of computing and/or electronic devices. An example set of computing and/or electronic devices, for customer premises 205, are illustrated and may include: mobile device 210, display device 212, and router 214. Fewer or additional computing and/or electronic devices may be present in any particular customer premise 205.

Mobile device 210 may include a portable communication device that is capable of connecting to a wireless network, such as wireless network 230. In one implementation, mobile device 210 may include a smart phone, a personal digital assistant (“PDA”) (e.g., that can include a radiotelephone, a pager, Internet/intranet access, etc.); a laptop computer; a tablet computer; or another type of mobile computation and communication device. In some implementations, mobile device 210 may include multiple radio interfaces, which may allow mobile device 210 to connect to multiple different wireless networks (e.g., to a cellular network corresponding to wireless network 230 and to local wireless network (e.g., Wi-Fi) provided by router 214).

Display device 212 may include a television, a computer monitor, a tablet computer, or another device that includes a display. In general, the display provided by display device 212 may be larger and/or of a higher resolution than a display provided by mobile device 210. Display device 212 may also provide an audio output (e.g., speakers). As described herein, a user of mobile device 210 may use display device 212 (i.e., the video and audio output of display device 212) as part of an online gaming experience. In one implementation, display device 212 may include the ability to accept an external audio/visual signal. For example, display device 212 may include the ability to accept an external audio/visual signal through a wired (e.g., high-definition multimedia interface (HDMI)) interface or a wireless interface. Providing audio/visual signals from a mobile device to a display device will be referred to herein as “screencasting.” A number of screencasting technologies are known and may be implemented by display device 212 and/or mobile device 214. For example, suitable screencasting technologies may include Miracast™, IEEE 802.11 ad based screencasting technologies, WirelessHD, AirPlay, Bluetooth 4.0, Digital Living Network Alliance (DLNA) based technologies, Mobile High-Definition Link (MHL) based technologies, and/or other technologies.

Router 214 may include a consumer routing device, such as a wireless router or switch that implements a local area network in customer premise 205. Router 214 may include, for example, an interface to wired network 220 (or an interface to another device, such as a cable modem or fiber node, that provides connectivity to wired network 220) and a wireless interface to customer premise 205. For example, router 214 may implement a Wi-Fi network within customer premise 205. In some situations, mobile device 210 may be enabled as a mobile hotspot (e.g., to provide Internet connectivity one or more other devices in customer premises 205 via wireless network 230). In this situation, mobile device 210 may itself act as a router and a separate router 214 may not be necessary.

Wired network 220 may include one or more networks, such as a local area network (“LAN”), a wide area network (“WAN”—such as the Internet), or another type of network. Wired network 220 may provide network connectivity, to customer premises 205, via a wired connection. For example, an operator of wired network 220, such as a telecommunications company, may provide network connectivity to customer premises 205 by installing install coaxial or fiber cables to the customer premises.

Wireless network 230 may include one or more networks that provide wireless network connectivity to customer premises 205 and/or mobile devices 210. For example, wireless network 230 may represent a wireless network that provides cellular wireless coverage. In some implementations, and as described in more detail below, wireless network 230 may be associated with an evolved packet system (“EPS”) that includes a Long Term Evolution (“LTE”) network and/or an evolved packet core (“EPC”) network that operate based on a Third Generation Partnership Project (“3GPP”) wireless communication standard. A radio access network (RAN) associated with wireless network 230 may include one or more base stations, some or all of which may take the form of an evolved node B (“eNB”).

Game server 240 may include one or more computing devices that provide data and/or services to end-user computing devices (e.g., mobile devices 210). Although referred to as a “server” herein, game server 240 may include a single computing device, clusters of computing devices (e.g., blades or rack mounted server computers) that are co-located or geographically distributed, cloud-based (e.g., computing as a service) computing solutions, or other arrangements of computing devices. Game server 240 may include logic and storage to implement one or more computer games. Functionality associated with the computer games be provided, over wireless network 230 and/or wired network 220, to consumer devices, such as mobile device 210. A game may be provided to mobile device 210 as a gaming stream that includes a video/audio stream of the game display or as a gaming stream that includes other game data. Mobile device 210 may run a gaming client that may handle user input and display of the gaming stream. Game server 230 may receive messages, from mobile devices 210, and based on the received messages, may generate the gaming stream.

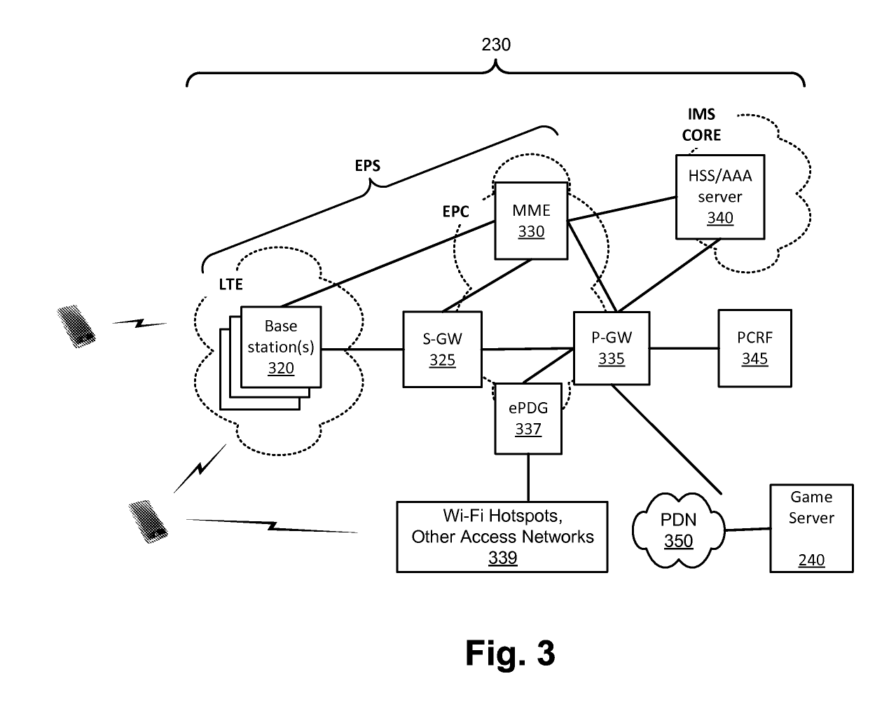

FIG. 3 is a diagram illustrating one example of an implementation of wireless network 230. Wireless network 230 may include an evolved packet system (“EPS”) that includes a long term evolution (“LTE”) network and/or an evolved packet core (“EPC”) network that operates based on a third generation partnership project (“3GPP”) wireless communication standard. The LTE network may provide relatively low latency connections to mobile devices 210, which may benefit from online gaming. The LTE network may be, or may include, a radio access network that includes one or more base stations 320, some or all of which may take the form of an eNodeB (“eNB”), via which mobile devices 210 may communicate with the EPC network. The EPC network may include one or more serving gateways (S-GWs) 325, mobility management entities (MMES) 330, packet data network gateways (PGWs) 335, and/or evolved packet data gateways (ePDG) 337, and may enable mobile devices 210 to communicate with an external network, game server 240, and/or an Internet protocol (“IP”) multimedia subsystem (“IMS”) core network. The IMS core network may include HSS/AAA server 340, and may manage authentication, session initiation, account information, a user profile, etc. associated with mobile devices 210.

Base station 320 may include one or more network devices that receive, process, and/or transmit traffic, such as voice calls and data, destined for and/or received from mobile device 210. In one example, base station 320 may be an eNB device and may be part of the LTE network. Base station 320 may receive traffic from and/or send traffic to external networks and/or game server 240 via SGW 325 and PGW 335. Base station 320 may send traffic to and/or receive traffic from mobile devices 210 via an air interface.

SGW 325 may include one or more network devices that gather, process, search, store, and/or provide information. SGW 325 may, for example, aggregate traffic received from one or more base stations 320 and may send the aggregated traffic to an external network via PGW 335.

MME 330 may include one or more computation and communication devices that gather, process, search, store, and/or provide information. For example, MME 330 may perform operations to register a mobile device 210 with the EPS, to establish bearer channels associated with a session with mobile device 210, to hand off mobile device 210 from the EPS to another network, to hand off mobile device 210 from the other network to the EPS, and/or to perform other operations. MME 330 may perform policing operations on traffic destined for and/or received from mobile device 210.

PGW 335 may include one or more network devices, or other types of computation and communication devices. PGW 335 may aggregate traffic received from one or more SGWs 325, and may send the aggregated traffic to an external network (e.g., packet data network (PDN) 350) and/or game server 240. PGW 335 may also, or alternatively, receive traffic from the external network and/or game server 240 and may send the traffic toward mobile device 210 via SGW 325, and/or base station 320.

ePDG 337 may include one or more network devices to provide interworking services between the EPC and untrusted, fixed non-3GPP networks that require secure access, such as Wi-Fi hotspots and small cells, including femtocell access networks (illustrated as Wi-Fi Hotspots, Other Access Networks 339). ePDG 337, as with PDN 350, may act as an access point, for game server 240 (either directly or through PDN 350), to wireless network 230.

HSS/AAA server 340 may include one or more server devices, or other types of devices, that gather, process, search, store, and/or provide information. For example, HSS/AAA server 340 may manage, update, and/or store, in a memory associated with HSS/AAA server 340, profile information associated with a subscriber. The profile information may identify applications and/or services that are permitted for and/or accessible by the subscriber; a mobile directory number (“MDN”) associated with the subscriber; bandwidth or data rate thresholds associated with the applications and/or services; information associated with the subscriber (e.g., a username, a password, etc.); rate information; minutes allowed for a subscriber; and/or other information. The subscriber may be associated with mobile device 210. Additionally, or alternatively, HSS/AAA server 340 may perform authentication, authorization, and/or accounting operations associated with the subscriber and/or a communication session with mobile device 210.

PCRF 345 may include one or more server devices, or other types of devices, that aggregate information to and from the EPC network and/or other sources. PCRF 345 may receive information regarding policies and/or subscriptions from one or more sources, such as subscriber databases and/or from one or more users (such as, for example, an administrator associated with PCRF 345).

When implementing online gaming over a network, such as wireless network 230, it may be important to provide network connectivity, from game server 240 to mobile device 210, that is adequate (e.g., in terms of latency and bandwidth) for a good user game experience. An LTE network may include comprehensive Quality of Service (QoS) and policy management processes that can validate service quality to ensure subscriber QoE (Quality of Experience). For example, in the LTE network of FIG. 3, and EPS bearer may be a logical aggregation of one or more IP (Internet Protocol) flows, and may provide connectivity to PDNs, such as PDN 350. The EPS bearer may extend from mobile devices 210 to P-GW 335. A default bearer may be established when a mobile device connects to PDN 350 and may remain in place as long as the PDN connection is alive. In LTE, dedicated bearers may be setup when new IP flows that require specific packet forwarding treatment are started and the IP flows can be GBR (Guaranteed Bit-Rate) or non-GBR. In one implementation, GBR bearers may used to communicate between mobile devices 210 and game sever 240. The GBR bearers may be particularly useful for video and gaming services that require high bandwidth and low latency, jitter and packet loss.

In one implementation, game server 240 may be implemented as a managed service that is directly connected to wireless network 230 or connected to wireless network 230 via a managed connection with a known or controlled QoS. For example, game server 240 may be directly connected to a dedicated P-GW 335. In this manner, gaming-related IP flows between game server 240 and mobile devices 210 may be strictly managed with respect to the end-to-end connection, thus potentially ensuring desired bandwidth, latency, jitter, and packet loss parameters.

The quantity of devices and/or networks, illustrated in FIG. 2 is provided for explanatory purposes only. In practice, there may be additional devices and/or networks; fewer devices and/or networks; different devices and/or networks; or differently arranged devices and/or networks than illustrated in FIGS. 2 and 3. Alternatively, or additionally, one or more of the devices illustrated in FIGS. 2 and 3 may perform one or more functions described as being performed by another one or more of the devices illustrated in FIGS. 2 and 3. The illustrated devices may interconnect via wired connections, wireless connections, or a combination of wired and wireless connections.

As discussed previously, mobile device 210 may include a gaming client that enables mobile device 210 to act as a local communication node for online games that are implemented by game server 240. In one implementation, the gaming client may be implemented as an application, such as an application that is installable by a user of mobile device 210 or an application that is installed during manufacture or provisioning of mobile device 210. Gaming client 400 may implement relatively little or no substantive functionality of the online game. In this sense, the gaming client may be considered to be a “thin” gaming client.

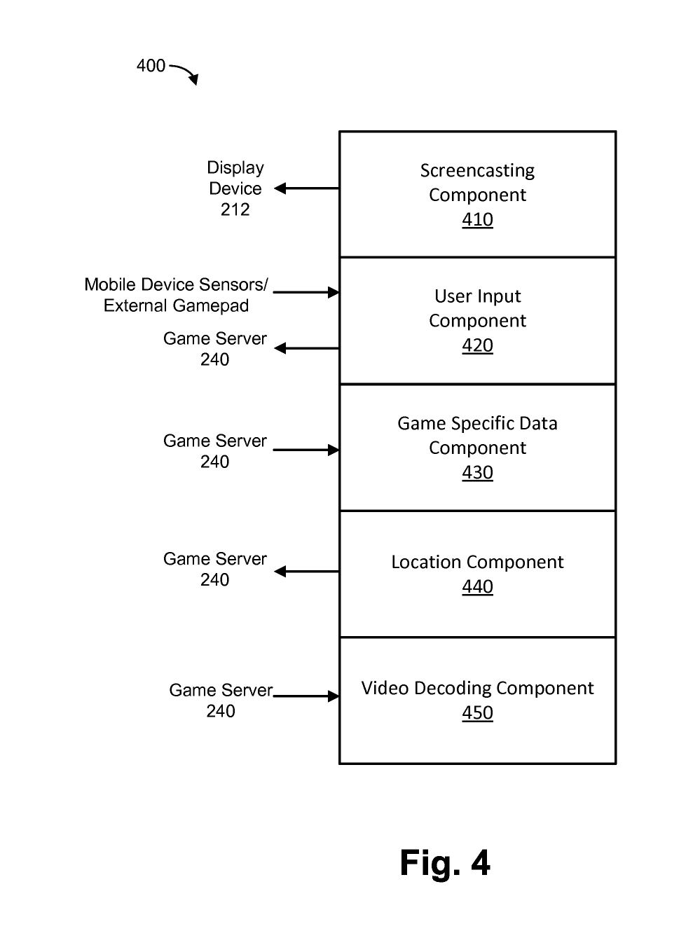

FIG. 4 is a diagram illustrating an example of functional components that may be included within a gaming client, illustrated as gaming client 400. Gaming client 400 may include screencasting component 410, user input component 420, game specific data component 430, location component 440, and video decoding component 450. In other implementations, gaming client 400 may include other or additional components than those illustrated in FIG. 4.

Screencasting component 410 may include logic to transmit (e.g., stream) a video stream (potentially also including audio) to display device 212. The video stream may represent the video and/or audio output of an online game that is currently being played by the user of mobile device 210. The video stream may be output to a display device that includes a large and/or high definition display relative to the display of mobile device 210. A number of potential screencasting technologies may be used to facilitate the display of the audio/video signal on the display device. For example, suitable screencasting technologies may include Miracast™, IEEE 802.11 ad based screencasting technologies, WirelessHD, AirPlay, Bluetooth 4.0, Digital Living Network Alliance (DLNA) based technologies, Mobile High-Definition Link (MHL) based technologies, and/or other technologies.

User input component 420 may include logic to receive user input that is relevant to an online game. The user input may be forwarded or otherwise transmitted to game server 240. In some situations, the user input may be provided directly through mobile device 210. For example, a touch screen display, microphone, accelerometer, gyroscope, or other input device or sensor, that is included as part of mobile device 210, may be used to receive user input. User input component 420 may cause a touch screen display, of mobile device 210, to display arrows, buttons, or other graphical representation that corresponds to actions in a particular online game. For example, a user swiping or selecting an arrow may correspond to a “move” command within the online game.

Alternatively or additionally to using sensors of mobile device 210 to generate input for an online game, in some implementations, an external gamepad or other input device may be used to generate the input. In this situation, user input component 420 may communicate with the external gamepad (or other input device) using a variety of possible local communication techniques (e.g., a short distance wireless connection, a universal serial bus (USB) cable connection, etc.). As one example, an external gamepad may include Bluetooth wireless technology. User input component 420 may, during initialization of the online game, establish a Bluetooth connection (i.e., a Bluetooth pairing) with the gamepad and may subsequently receive user input via the Bluetooth connection.

Game specific data component 430 may include logic to store and/or execute game specific data. In one implementation, the game specific data may be downloaded from game server 240 when a user initiates playing of a particular game. In some implementations, the game specific data may include game configuration information, such as: information identifying minimum resources required by a game (e.g., a minimum display resolution, a minimum network bandwidth requirements, minimum network latency requirements, etc.); information identifying types of input devices recommended for the game or required by the game (e.g., an accelerometer may be required, a particular touch screen user interface may be identified, one or more usable external gamepads may be identified, etc.); and/or information identifying network protocols that will be used to communicate between game server 240 and mobile device 210.

As one example of information that may stored by game specific data component 430, the game specific data may identify an interface (e.g., a virtual gamepad) that is used with the game. For example, gaming client 400 may be configured to provide a number of potential interfaces on mobile device 210. For example, a first interface may include an interface that provides, on a touch screen display of mobile device 210, “up,” “down,” “left,” and “right” arrows, and first and second button icons. Through this interface, the user may input game commands that indicate movement up, down, left, and right, and first and second commands (e.g., “fire weapon” and “jump”) that are sent in response to the user selecting the first and second button icons. A second interface may include a different arrangement of arrows, buttons, and other icons. A third interface may include another arrangement of icons on the touch screen display of mobile device 210, as well as enable transmission of acceleration information that is provided by mobile device 210. In this manner, gaming client 400 may provide a number of potential standardized game interfaces to game developers. The game developer may choose the interface that is most appropriate for the developer's particular game.

As another example of information that may be stored by game specific data component 430, the game specific data may identify a set of external gamepads that are supported by a particular game. For example, a particular game may identify one or more gamepad manufacturers and models with which the particular game is compatible. Gaming client 400 may generate an error message if the user of mobile device 210 attempts to use a non-compatible gamepad.

In some implementations, the game specific data stored by game specific data component 430 may include executable instructions. For example, gaming client 400 may allow game developers to execute certain portions of a game locally (i.e., at mobile device 210), thereby allowing for certain portions of the substantive game functionality to be implemented by mobile device 210. This may provide game developers with additional flexibility in handling latency sensitive game processes. For example, it may be desirable for an action game to provide immediate feedback in response to certain user actions. The feedback may be generated locally to provide a more responsive gaming experience.

Location component 440 may include logic to obtain a location of mobile device 210 and provide the location to game server 240. Location information of mobile device 210 may be obtained, for example, based on GPS (global positioning system) techniques or based on other location-determination techniques (e.g., base station triangulation, a user explicitly entering their location, etc.). Location information may be used by game server 240 in applications such as social gaming (e.g., to locate nearby gamers) or to optimize the routing of communications between game server 240 and mobile device 210.

Video decoding component 450 may include logic to decode the gaming stream from game server 240. The decoded gaming stream may be provided to screencasting component 410 for display on display device 212. As an example, in one implementation, the gaming stream from game server 240 may be a MPEG (Moving Picture Experts Group) encoded audio/video stream. Video decoding component 450 may decode the gaming stream into a format suitable for screencasting. As another example, the gaming stream from game server 240 may be encoded using another format (e.g., a stream of instructions defining the rendering of vector-based graphics) suitable for converting into the video/audio rendering of the game.

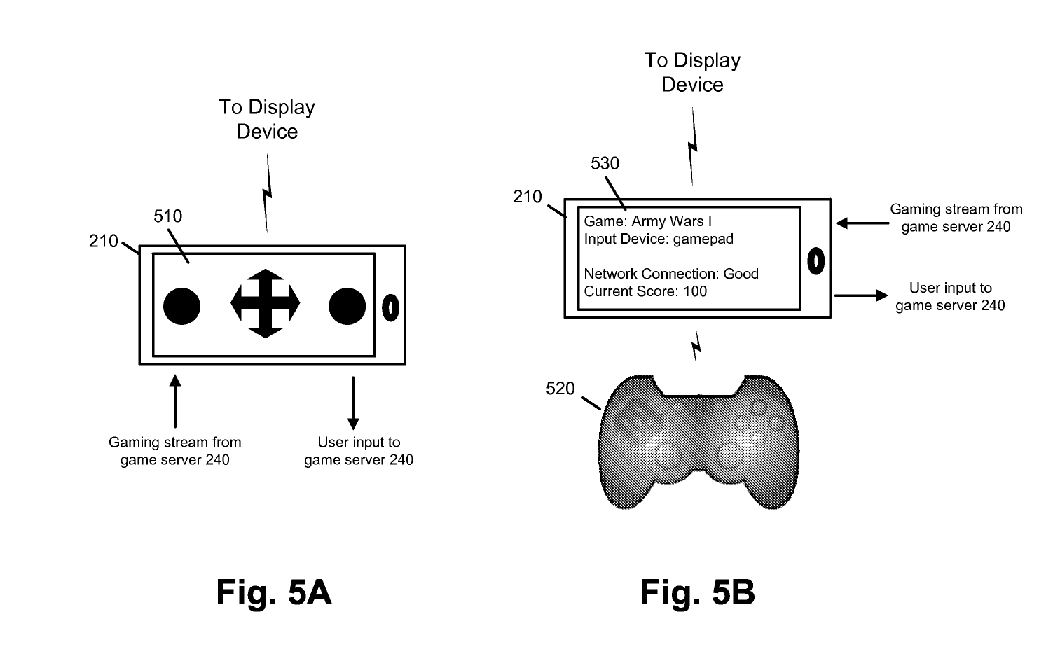

FIGS. 5A and 5B are diagrams illustrating example device configurations for receiving user input for a game. The user input may be provided as discussed previously with respect to user input component 420 of gaming client 400. As illustrated in FIG. 5A, mobile device 210 may be used to obtain the user input. Mobile device 210 may provide a graphical interface 510 that includes one or more graphical icons (e.g., arrows, buttons, etc.) with which the user may interact to generate user input information. The graphical icons may provide visual feedback to indicate the user interactions with the graphical icons (e.g., in response to the selection of a graphical button, a sound may be emitted by mobile device 210 and/or the graphical button may visually indicate pressing of the button).

As illustrated in FIG. 5B, mobile device 210 may obtain user input through an external gamepad 520. As previously mentioned, mobile device 210 may connect to external gamepad 520 through a wireless (e.g., short distance wireless connection) or wired (e.g., USB cable) connection. Mobile device may forward the user input, received from gamepad 520, to game server 240. In some implementations, the display of mobile device 210 may be used to provide additional information, relating to the game, to the user. For example, as illustrated in FIG. 5B, interface 530, of mobile device 210, provides textual information that includes the name of the current game (“Army Wars I”), the input device being used (“gamepad”), information describing the current network connection with game server 240 (“Good”), and information pertaining to the game being played (e.g., the user's score is shown as 100).

In yet another possible implementation, display device 212 may directly receive display data (e.g., a video stream) from game server 240. In this case, display device 212 may include logic to obtain network connectivity (e.g., via Wi-Fi) to obtain the display data. As with the implementations described above, mobile device 210 may continue to receive game input data (e.g., either directly through a touch screen of mobile device 210 and/or via a connected gamepad) and transmit the game input data to game server 240, as well as potentially provide an additional output device for the game, such as via the touch screen display.

In yet another possible implementation, mobile device 210 may enable display device 212 or assist display device 212 in providing high definition content. For example, a display device 212 may be capable of providing high definition television (HDTV) or ultra high definition television (UHDTV) content but may not have a useable or up-to-date decoder installed. In this situation, mobile device 210 may perform the decoding of the HDTV or UHDTV signal for display device 212.

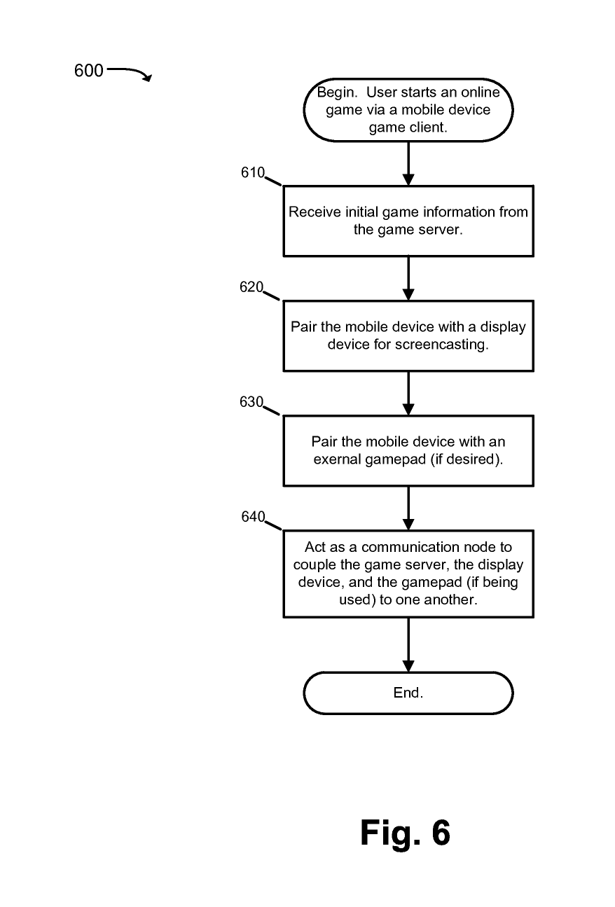

FIG. 6 is a flow chart illustrating an example process 600 relating to the providing of an online game using a mobile device and a display device. In one implementation, process 600 may be performed by gaming client 400 of mobile device 210. Process 600 may be performed in response to a user initiating the playing of a game through gaming client 400.

Process 600 may include receiving initial game information from the game server (block 610). The game information may correspond to information stored by game specific data component 430. As previously mentioned, this data may include, for example: information identifying an interface that is to be provided by mobile device 210 to receive user input; information identifying minimum resources, at mobile device 210, that are required by the game; information identifying external gamepads that are supported by the game; information identifying or implementing executable components of the game; or other information.

Process 600 may further include pairing the mobile device with a display device for screencasting (block 620). Pairing the mobile device with a display device may generally involve connecting mobile device 210 to display device 212 in a manner that allows video (and/or audio) to be transmitted to and displayed by display device 212. The pairing process may be part of the initiation of the screencasting session. As previously mentioned, in some implementations, screencasting of the game audio or video, to display device 212, may be performed using a number of possible screencasting technologies. Using a wireless screencasting technology may be particularly useful when mobile device 210 is used as a game input device. Mobile device 210 may also be connected to display device 212 using a physical cable, such as an HDMI cable or a Mobile High-Definition Link (MHL) cable. MHL may allow for the connection of a mobile device 210 to a display device 212, while charging the mobile device.

In some implementations, security may be provided as part of the pairing of mobile device 210 to display device 212. For example, a password may be required to authenticate wireless screencasting between mobile device 210 and display device 212. In another possible implementation, a Near Field Communication (NFC) technology may be used to authenticate the wireless screencasting between mobile device 210 and display device 212. In some implementations, for wireless screencasting, the wireless signal between mobile device 210 and display device 212 may be encrypted to provide security. The encryption may be based on, for example, Advanced Encryption Standard (AES) based encryption (e.g., 256 or 128 bit AES encryption), the High-Bandwidth Digital Content Protection (HDCP) standard, the Digital Transmission Content Protection (DTCP) standard, etc.

Process 600 may further include pairing the mobile device with an external gamepad (block 630). Pairing mobile device 210 with an external gamepad may be performed as a user initiated option. For example, gaming client 400 may provide an option to allow the user to connect an external gamepad to control the game. Otherwise, gaming client 400 may use input sensors of mobile device 210 (e.g., a touch screen, accelerometer, gyroscope, etc.) to receive user input that controls the game. In one implementation, pairing the mobile device with an external gamepad may be performed via a wireless interface, such as a Bluetooth interface or other wireless interface.

Process 600 may further include acting as a communication node to couple the game server, the display device, and the external gamepad (if being used) to one another (block 640). For example, in the situation in which mobile device 210 is paired with a display device (e.g., large screen television) for screencasting and with a external gamepad, mobile device 210 may receive user input from the external gamepad, transmit the input to game server 240, receive a game stream from game server 240, and based on the game stream, provide an audio/video screencast to the display device. In the situation in which mobile device 210 is paired with a display device for screencasting (but not with an external gamepad), mobile device 210 may receive user input based on user interaction with the mobile device, transmit the input to game server 240, receive a game stream from game server 240, and based on the game stream, provide an audio/video screencast to the display device. In one implementation, the game stream may be an audio/video stream. In another possible implementation, the game server may include other information that may be used by gaming client 400 to generate an audio/video stream for display device 212.

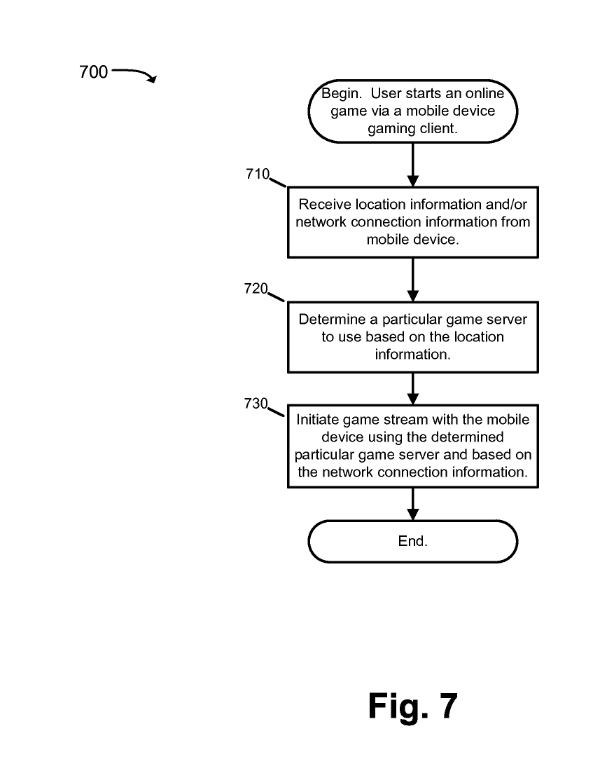

FIG. 7 is a flow chart illustrating an example process 700 relating to the providing of an online game using a mobile device and a display device. In one implementation, process 700 may be performed by game server 240. Process 700 may be performed as part of the initial establishment of a game session with mobile device 210.

Process 700 may include receiving location information and/or network connection information from the mobile device (block 710). For example, location component 440 of gaming client 400 may transmit the current location of mobile device 210 to game server 240. Alternatively or additionally, gaming client 400 may provide additional information to game server 240, such as information relating to the current network connectivity of mobile device 210. For example, mobile device 210 may be connected to one or both of wired network 220 and wireless network 230. Game server 240 may use the network connectivity information, associated with mobile device 210, to optimize the transmission of the game stream to mobile device 210.

Process 700 may further include determining a particular game server to use based on the location information (block 720). Game server 240 may include a number of physical servers and/or server clusters that are potentially geographically distributed. It may be desirable, such as to reduce network latency, to use a particular physical server and/or server cluster that is as close as possible to the location of mobile device 210. In one implementation, determining the particular game server may thus include determining the particular game server based on the location information of the network device (e.g., the particular game server may be chosen as the game server that is geographically closest to mobile device 210).

Process 700 may further include initiating the game stream with the mobile device using the determined particular game server and based on the network connection information (block 730). In one implementation, when mobile device 210 is determined to be associated with multiple network connections, the game stream may be transmitted over a higher bandwidth and/or lower latency connection. For example, mobile device 210 may be simultaneously connected to wireless network 230, via a wireless cellular connection, and to wired network 220, via a high-bandwidth fiber connection. In this case, the game stream may be transmitted over the high-bandwidth fiber connection. In another possible implementation, gaming client 400 may allow a user to choose or prioritize the network connections that are to be used for online gaming. For example, the user may indicate that only one particular type of network connection is to be used (e.g., only the connection to wired network 220) or that a first type of network connection is to be given higher priority relative to a second type of network connection. In another possible implementation, multiple network connections, such as a connection over wired network 220 and wireless network 230, may be used to simultaneously transmit the game stream. In this implementation, mobile device 210 may aggregate or otherwise assemble data received over the multiple network connections to create a single usable game stream. In this manner, multiple network connections may be potentially used to increase the available bandwidth.

The above description of online gaming was primarily described in relation to a single user, associated with a single mobile device 210, playing an online game. In other possible implementations, multiple users may play a single game or game instance (e.g., a multiplayer game) and/or additional users may view an ongoing game between other users.

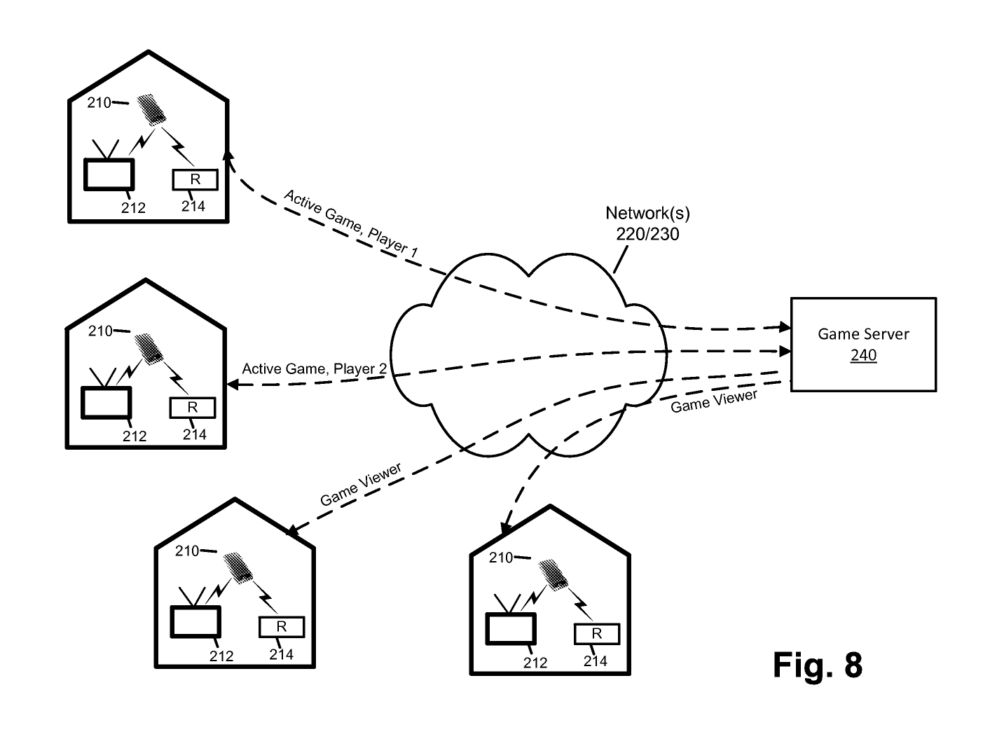

FIG. 8 is a diagram conceptually illustrating an example implementation of a multiplayer game implemented using mobile devices and display devices. As illustrated, a number of mobile devices 210 may connect to game server 240 for online gaming. As described previously, mobile devices 210 may use display devices 212 to screencast the video/audio presentation associated with a game.

As illustrated, assume two of mobile devices 210 connect with game server 240 to actively play a game (the connections labeled “Active Game, Player 1” and “Active Game, Player 2”), such as a multiplayer game. Game server 240 may keep track of a state of both players in the game and transmit game streams to the mobile devices associated with “Player 1” and “Player 2,” where the game streams include the state of both players. In this manner, game server 240 may implement a multiplayer game in which the active players in the multiplayer game may interact with one another.

In some implementations, game server 240 may additionally support the ability to allow other users to join the active game in a “view only” mode in which the users can view the game being played by the active players (e.g., “Player 1” and “Player 2”) but not actively participate in the game. For example, two of mobile devices 210, as illustrated in FIG. 8, may connect with game server 240 in “view only” mode (the connections labeled “Game Viewer”). In this mode, the corresponding mobile devices 210 may screencast a video/audio representation of the game to the current display devices 212. However, no interaction or limited user interaction may be allowed with the game (e.g., a user's interaction may be limited to controlling the point of view that is seen by the user and/or in-game texting to other “view only” mode users). In some implementations, the game stream transmitted to the view only users may be broadcast or multicast over wireless network 230 (e.g., as a Multimedia Broadcast Multicast Service (MBMS) or enhanced MBMS (eMBMS) transmission). Broadcasting or multicasting the content associated with “view only” mode users, using wireless network 230, may be an efficient use of network resources because multiple mobile devices may receive the game stream using a shared radio signal.

In some situations, display device 212 may be a high resolution display device is that capable of providing multiple simultaneous displays to different users. For example, display device 212 may include an HDTV that is a capable of simultaneously providing two visual streams, each using the entire display area of the HDTV, to two different users. The two users may wear glasses, such as polarized glasses, that are designed to filter out the visual stream for the other user. In this manner, the two users may be in the same room and looking at the same HDTV, but each user may see a different visual stream on the HDTV. One implementation of this technology is SimulView™, available from Sony Corporation.

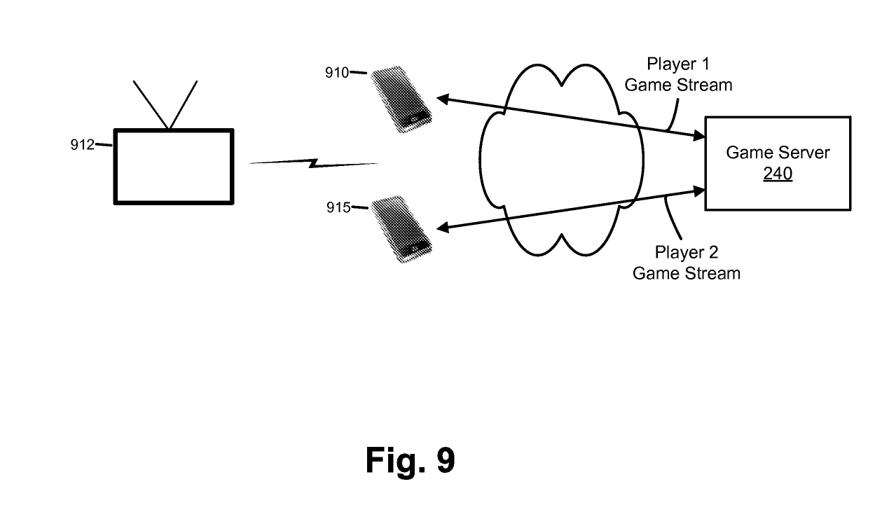

FIG. 9 is a diagram illustrating an example of an implementation in which multiple users may use a single display device to play an online game. As illustrated, two mobile devices 910 and 915, which may each be similar to mobile device 210, may be used to play an online game in which the visual stream for the game is provided on a single display device 912. Display device 912 may provide a visual stream, associated with the game, for each of the user's of mobile devices 910/915. For example, the game interface may be provided as a “split screen” on display device 912 in which the visual stream corresponding to a first player of the game (“Player 1”) may be provided in a first half of the display and in which the visual stream corresponding to a second player of the game (“Player 2”) may be provided in a second half of the display. Alternatively, the visual streams corresponding to the point of view of the first and second players may be simultaneously provided on the entire display in a manner in which glasses worn by the two players may filter out the visual stream of the other player (e.g., using SimulView™ technology).

In one implememtation, game server 240 may separately connect to mobile devices 910 and 915 to provide a game stream (“Player 1 Game Stream” and “Player 2 Game Stream”) to each of mobile devices 910 and 915, respectively. In one implementation, the visual stream, to screencast to display device 912, may be independently transmitted by each mobile device 910 and 915, to display device 912. That is, screencasting may be initiated by mobile devices 910 and 915 separately pairing and transmitting a visual stream to display device 912. In another possible implementation, only one of mobile devices 910 and 915 may pair with display device 912. In this implementation, the other mobile device may transmit the visual stream to the first mobile device, which may transmit the combined visual stream to display device 912.

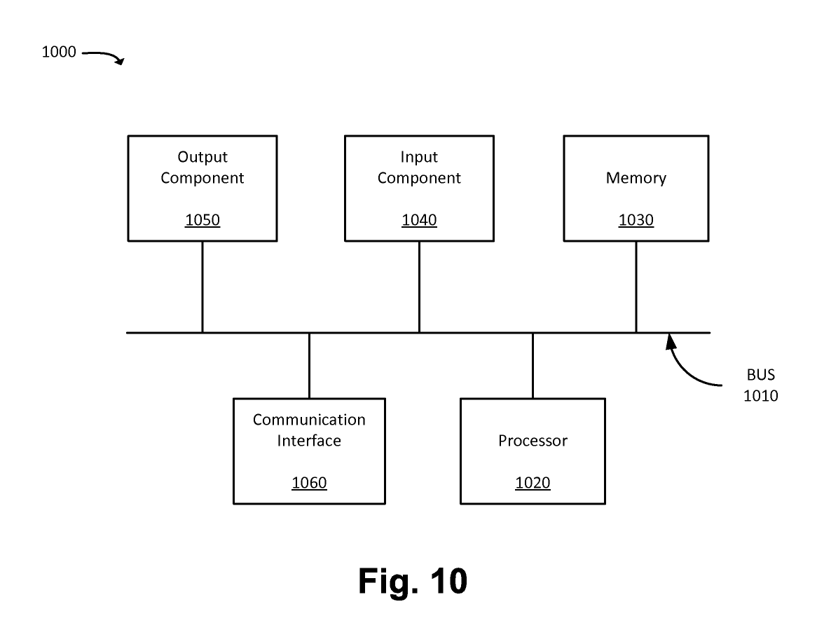

FIG. 10 is a diagram of example components of device 1000. One or more of the devices described above (e.g., as described with respect to FIGS. 1-5, and 9) may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth radio, a Wi-Fi radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1130 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while series of blocks have been described with regard to FIGS. 6 and 7, the order of the blocks may be modified in other implementations. Further, non-dependent blocks may be performed in parallel.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method implemented by a mobile device, the method comprising:
receiving, by the mobile device, an information stream relating to an online game, the information stream being received from a remote game server;
receiving, by the mobile device, user input relating to the online game;
transmitting, by the mobile device, the user input to the game server; and
screencasting, by the mobile device and to a local display device, a video stream that is based on the information stream, the video stream representing a display corresponding to the online game.

2. The method of claim 1, wherein the information stream includes a video signal.

3. The method of claim 1, wherein the user input relating to the online game is received from an external gamepad that is paired with the mobile device via a local wireless connection.

4. The method of claim 1, wherein screencasting the video stream further includes:
pairing the mobile device with the local display device to initiate a wireless screencasting session; and
transmitting the video stream, via the wireless screencasting session, to the display device.

5. The method of claim 1, wherein the user input relating to the online game is received based on user interaction with a touch screen display of the mobile device, and wherein the method further comprises:
receiving, from the game server, information selecting one of a plurality of interfaces that are to be displayed on the touch screen display to obtain the user input; and
presenting the selected one of the plurality of interfaces on the touch screen display,
wherein the user input is received via the selected one of the plurality of interfaces.

6. The method of claim 5, wherein the user input includes at least one of data relating to user touching of the touch screen display, data from a gyroscope sensor of the mobile device, or data from an accelerometer sensor of the mobile device, and wherein the information stream relating to the online game is based on the user input.

7. The method of claim 1, further comprising:
connecting, by the mobile device and through a first radio interface, to a Long Term Evolution (LTE) network; and
receiving the information stream over the LTE network.

8. The method of claim 1, further comprising:
receiving information relating to the online game, the information relating to the online game including at least one of:
information identifying minimum resources required by the online game,
information identifying types of external gamepads compatible with the online game, or
executable instructions to implement portions of the online game locally at the mobile device; and
storing the received information at the mobile device.

9. A mobile device comprising:
a memory; and
at least one processor to execute instructions in the memory to:
receive an information stream relating to an online game, the information stream being received from a remote game server;
receive user input relating to the online game;
transmit the user input to the game server; and
screencast, to a local display device, a video stream that is based on the information stream, the video stream representing a display corresponding to the online game.

10. The mobile device of claim 9, wherein the information stream includes a video signal.

11. The mobile device of claim 9, wherein the user input relating to the online game is received from an external gamepad that is paired with the mobile device via a local wireless connection.

12. The mobile device of claim 9, wherein the instructions to screencast the video stream further include instructions, when executed by the at least one processor, to:
pair the mobile device with the local display device to initiate a wireless screencasting session; and
transmit the video stream, via the wireless screencasting session, to the display device.

13. The mobile device of claim 9, wherein the user input relating to the online game is received based on user interaction with a touch screen display of the mobile device, and wherein the instructions further includes instructions, when executed by the at least one processor, to:
receive, from the game server, information selecting one of a plurality of interfaces that are to be displayed on the touch screen display to obtain the user input; and
present the selected one of the plurality of interfaces on the touch screen display,
wherein the user input is received via the selected one of the plurality of interfaces.

14. The mobile device of claim 13, wherein the user input includes at least one of data relating to user touching of the touch screen display, data from a gyroscope sensor of the mobile device, or data from an accelerometer sensor of the mobile device.

15. The mobile device of claim 9, wherein the at least one processor is further to execute instructions in the memory to:
connect, through a first radio interface, to a Long Term Evolution (LTE) network; and
receive the information stream over the LTE network.

16. A method implemented by a mobile device, the method comprising:
pairing, by the mobile device, to a local display device to wirelessly screencast video to the display device;
pairing, by the mobile device, to an external gamepad to receive user input relating to an online game;
connecting, by the mobile device, to a Long Term Evolution (LTE) wireless network;
receiving, by the mobile device, an information stream relating to the online game, the information stream being received from a remote game server over the LTE wireless network;
receiving, by the mobile device and from the external gamepad, user input relating to the online game;
transmitting, by the mobile device, the user input to the game server; and
screencasting, by the mobile device and to the local display device, a video stream that is based on the information stream, the video stream representing a display corresponding to the online game.

17. The method of claim 16, wherein the user input relating to the online game is received based on user interaction with a touch screen display of the mobile device, and wherein the method further comprises:
receiving, from the game server, information selecting one of a plurality of interfaces that are to be displayed on the touch screen display to obtain the user input; and
presenting the selected one of the plurality of interfaces on the touch screen display,
wherein the user input is received via the selected one of the plurality of interfaces.

18. The method of claim 17, wherein the user input includes at least one of data relating to user touching of the touch screen display, data from a gyroscope sensor of the mobile device, or data from an accelerometer sensor of the mobile device, and wherein the information stream relating to the online game is based on the user input.

19. The method of claim 17, further comprising:
receiving information relating to the online game, the information relating to the online game including at least one of:
information identifying minimum resources required by the online game,
information identifying types of external gamepads compatible with the online game, or
executable instructions to implement portions of the online game locally at the mobile device; and
storing the received information at the mobile device.

20. The method of claim 16, wherein the display device includes a television.
